(19) United States
(12) Patent Application Publication
(10) Pub. No.: US 2015/0251141 A1
(43) Pub. Date: Sep. 10, 2015

(54) Apparatuses and Methods for Preventing Fouling and Scaling Using Ultrasonic Vibrations

(71) Applicant: UNIVERSITY OF WASHINGTON THROUGH ITS CENTER FOR COMMERCIALIZATION, Seattle, WA (US)

(72) Inventors: Pierre D. Mourad, Seattle, WA (US); Jaffer Alali, Redmond, WA (US); Brian Macconaghy, Kent, WA (US)

(73) Assignee: University of Washington Through Its Center for Commercialization, Seattle, WA (US)

(21) Appl. No.: 14/440,641

(22) PCT Filed: Nov. 5, 2013
(86) PCT No.: PCT/US13/68517

§ 371 Date: May 5, 2015

Related U.S. Application Data
(60) Provisional application No. 61/722,674, filed on Nov. 5, 2012.

(51) Int. Cl. B01D 71/68; B01D 71/56; C02F 1/44; B01D 71/02; B01D 71/34; B01D 65/08; B01D 61/00

(52) U.S. Cl. CPC B01D 71/68; B01D 65/08; B01D 71/56; B01D 61/00; B01D 71/024; B01D 71/34; C02F 1/44; C02F 2103/08

(57) ABSTRACT

Described herein are apparatuses and methods for preventing or otherwise reducing scaling and fouling of a membrane using ultrasonic vibrations. One example method involves: (1) directing a solution to a membrane of a membrane assembly, where the membrane passes a solvent of the solution through the membrane at a first rate, and where the membrane prevents at least some of a solute of the solution from passing through the membrane; and (2) causing a piezoelectric material that is physically coupled to the membrane to produce ultrasonic waves directed at the membrane, where the ultrasonic waves induce oscillations in at least a portion of the membrane and thereby the solvent of the solution passes through the membrane at a second rate that is greater than the first rate.

### RELATED APPLICATIONS

This application claims priority to U.S. Provisional Patent Application Ser. No. 61/722,674 filed Nov. 5, 2012, entitled Reducing The Cost Of Water Desalination, is incorporated herein in its entirety.

### BACKGROUND

Unless otherwise indicated herein, the materials described in this section are not prior art to the claims in this application and are tot admitted to be prior art by inclusion in this section.

Society's demand for fresh water is continually increasing. In some regions, demand for fresh water may exceed the available fresh water supply. In such regions, desalination, the process of extracting fresh water from seawater, may be utilized to help increase the supply of fresh water.

There are several methods of seawater desalination. For example, reverse osmosis is a leading desalination method that involves forcing seawater through a membrane that admits fresh water and rejects salt and other solutes. In general, desalination methods may pose a number of challenges. For example, such methods may be expensive to implement and may require a large amount of energy.

Further, different variations of particular desalination methods may present their own unique challenges. For example, in reverse osmosis desalination, membrane fouling may reduce the permeability of the membrane or possibly destroy the membrane, among other negative effects. Broadly speaking, fouling refers to the process where solute or particles attach to the membrane surface or otherwise clog the membrane pores thereby degrading the membrane's performance. Fouling may be the result of scaling, which is the formation of a layer of inorganic salts on the membrane surface, among other possible causes.

To combat the effects of fouling and scaling, chemicals may be added to the seawater before it passes through the membrane. However, after the seawater is desalinated, these chemicals may remain in the waste byproduct, which may in turn be passed into the environment, thereby causing harm to the ecosystem.

Another effort to reduce the effects of fouling and scaling may involve propelling the seawater at a high velocity through the membrane, Such an effort may reduce the accumulation of fouling matters on the surface of the membrane, but it may also damage or otherwise reduce the longevity of the membrane.

Other desalination and filtration methods may also face the challenges of fouling and scaling. For example, such problems may be faced in forward osmosis desalination and water filtration methods. Other fluid treatment methods that utilize a membrane may also face these challenges. Therefore, an improved approach for keeping membranes free of fouling and scaling is desire.

### SUMMARY

As noted, filtration processes, including desalination, face the challenges of membrane fouling and scaling. Adding chemicals to a solution before passing it through the membrane may marginally decrease scaling and fouling. However, the chemicals may be harmful to the environment. Further, propelling the solution through the membrane at a high velocity may minimally decrease accumulation of fouling matters. Nonetheless, such propulsion may reduce the longevity and/or the efficacy of the membrane.

Described herein are apparatuses and methods for preventing or otherwise reducing fouling and scaling of a membrane using ultrasonic vibrations. Such vibrations, on submicron scales or larger, may disrupt a layer of deposits that may accumulate near or at the pores of a membrane, thereby facilitating the movement of solvent (e.g. water) through the membrane. As a result of the reduction in fouling and scaling, the apparatuses and methods described herein may reduce the necessary propulsion velocity of the solution in certain treatment processes. Accordingly, the methods and apparatuses may help in increasing the efficacy of a membrane and the usable lifetime of the membrane. The apparatuses and methods described herein may be applied to any system or device that utilizes a membrane that may be susceptible to fouling or scaling.

In a first aspect, a membrane assembly is provided. The membrane assembly may include: (1) a membrane, where the membrane is configured to allow a solvent of a solution to pass through the membrane, and where the membrane is configured to prevent at least some of a solute of the solution from passing through the membrane; and (2) a piezoelectric material physically coupled to the membrane, where the piezoelectric material is configured to produce ultrasonic waves directed at the membrane and thereby induce oscillations in at least a portion of the membrane.

In a second aspect, a method is provided. The method may involve: (1) directing a solution to a membrane of a membrane assembly, where the membrane passes a solvent of the solution through the membrane at a first rate, and where the membrane prevents at least some of a solute of the solution from passing through the membrane; and (2) causing a piezoelectric material that is physically coupled to the membrane to produce ultrasonic waves directed at the membrane, where the ultrasonic waves induce oscillations in at least a portion of the membrane and thereby the solvent of the solution passes through the membrane at a second rate that is greater than the first rate.

In a third aspect, a membrane assembly is provided. The membrane assembly may include: (1) a membrane, where the membrane is configured to allow a solvent of a solution to pass through the membrane, and where the membrane is configured to prevent at least some of a solute of the solution from passing through the membrane; (2) a spacer physically coupled to the membrane, where the spacer is configured to direct the solution through the membrane assembly; and (3) a piezoelectric material physically coupled to the spacer, where the piezoelectric material is configured to produce ultrasonic waves directed at the membrane and thereby induce oscillations in at least a portion of the membrane,

These as well as other aspects, advantages, and alternatives, will become apparent to those of ordinary skill in the art by reading the following detailed description, with reference where appropriate to the accompanying drawings.

### BRIEF DESCRIPTION OF THE FIGS.

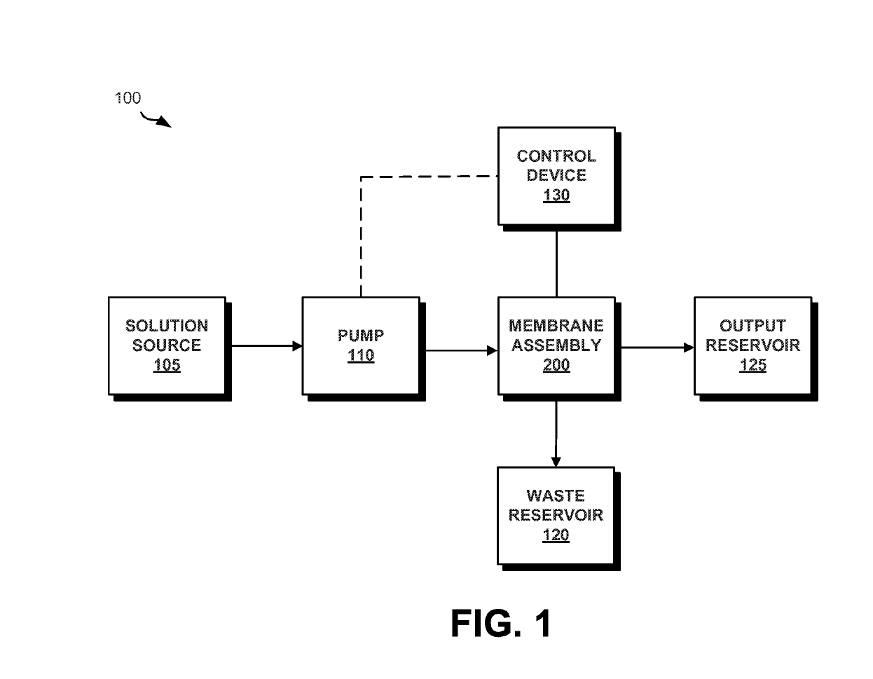

FIG. 1 depicts a simplified block diagram of a treatment system that includes an example membrane assembly, in accordance with an embodiment.

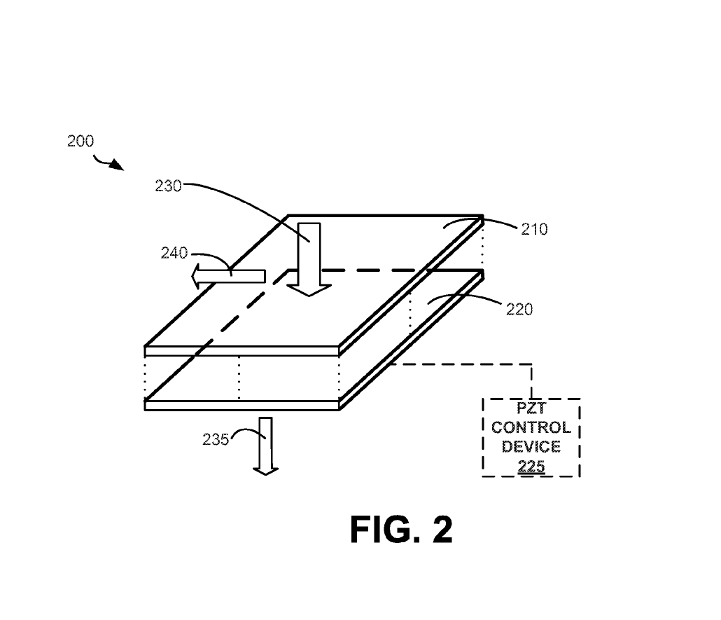

FIG. 2 depicts a simplified block diagram of an embodiment of the example membrane assembly, in accordance with an embodiment.

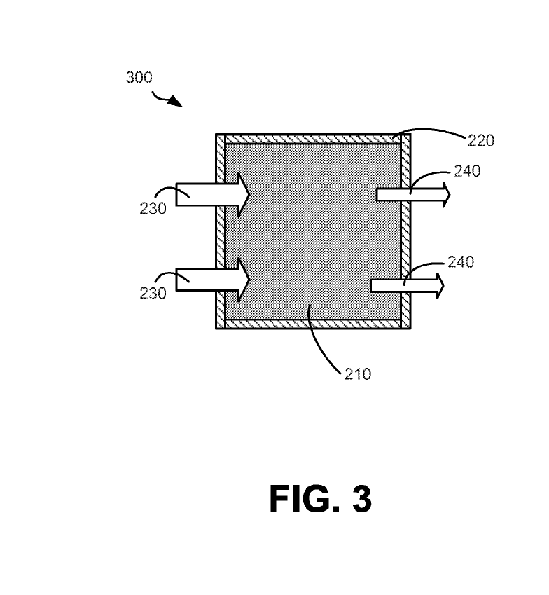

FIG. 3 depicts a top-down view of an example membrane assembly, in accordance with an embodiment.

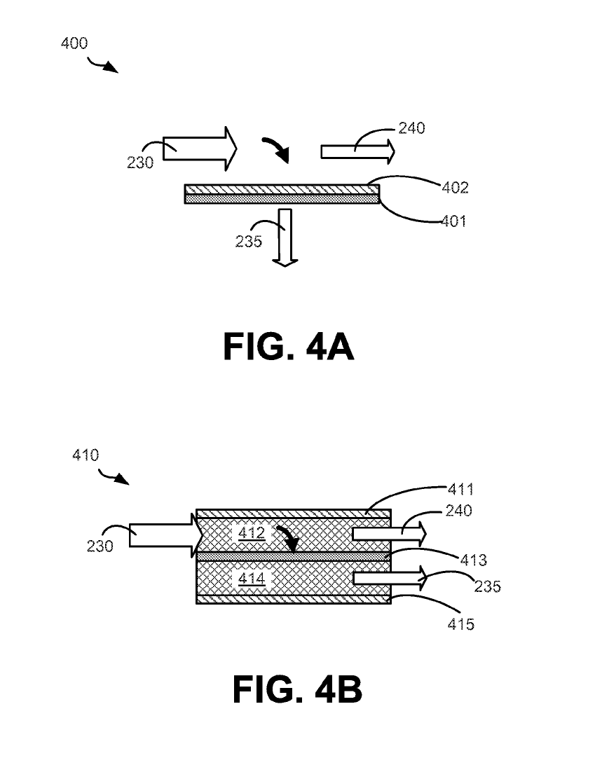

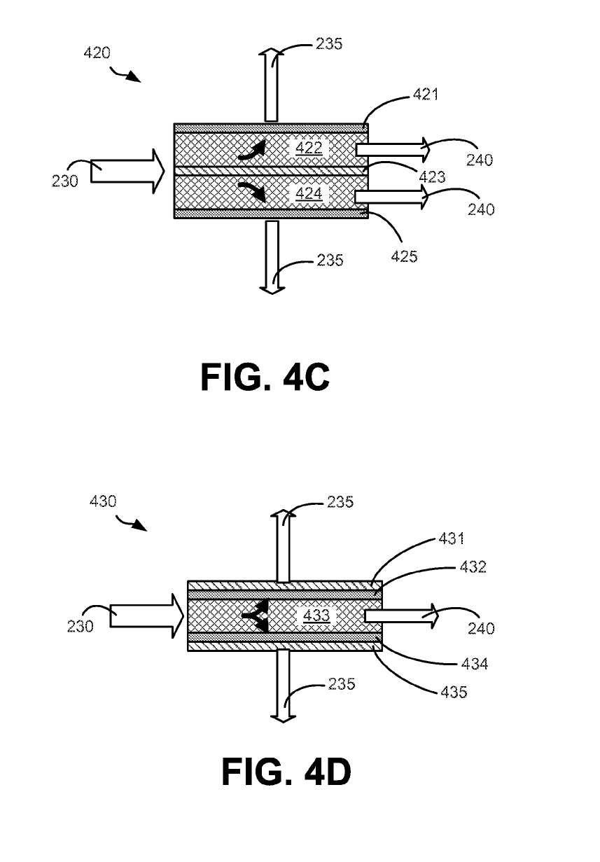

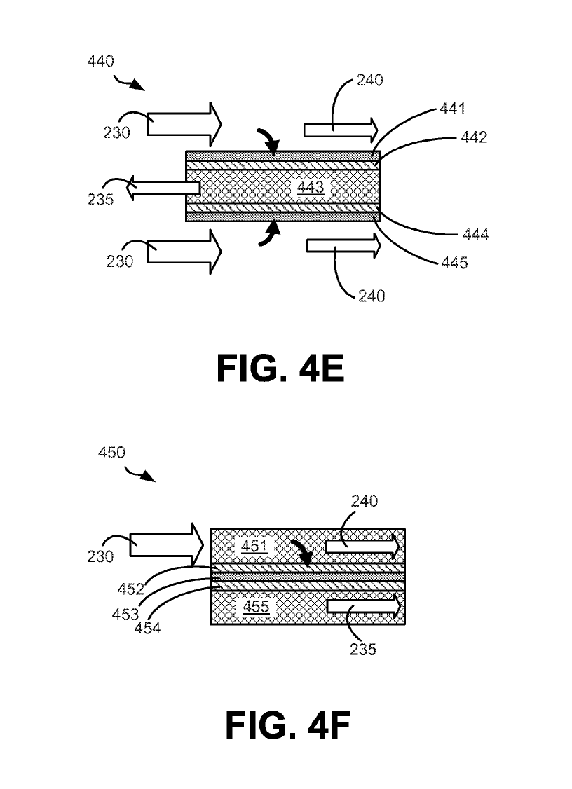

FIGS. 4A-4F depict simplified block diagrams of embodiments of example membrane assemblies according to example embodiments.

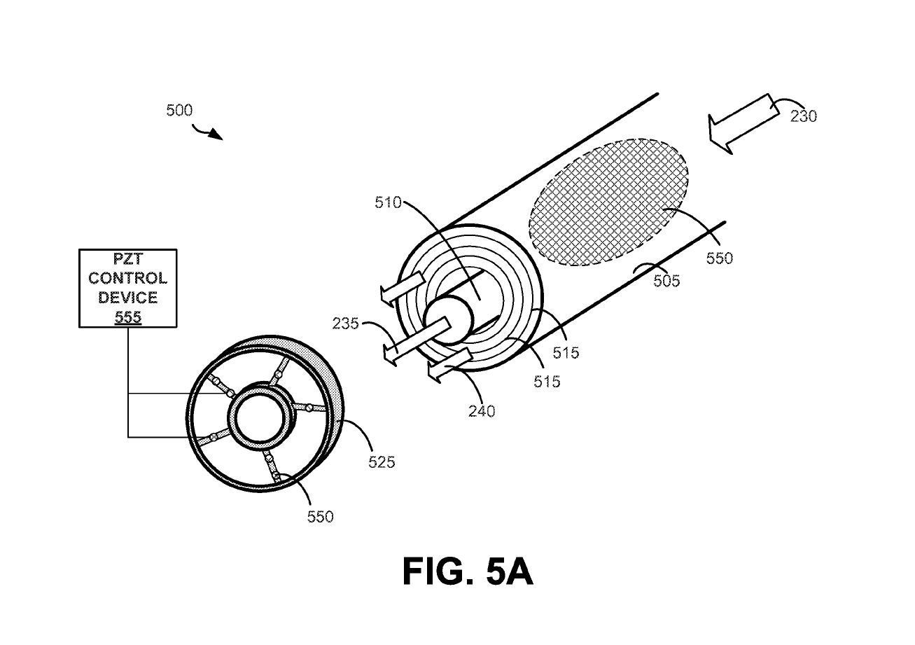

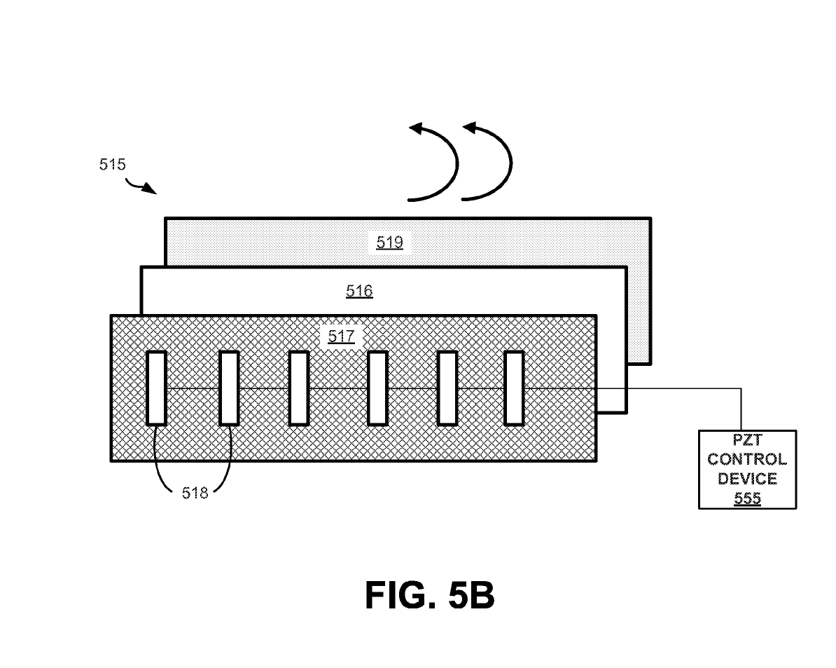

FIG. 5A depicts an example application of a membrane assembly, in accordance with an embodiment.

FIG. 5B depicts the membrane assembly of FIG. 5A, in accordance with an embodiment.

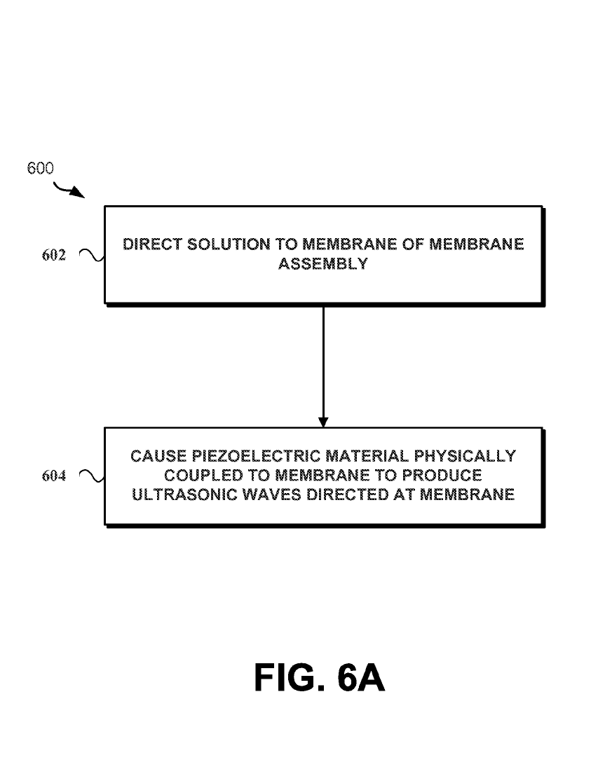

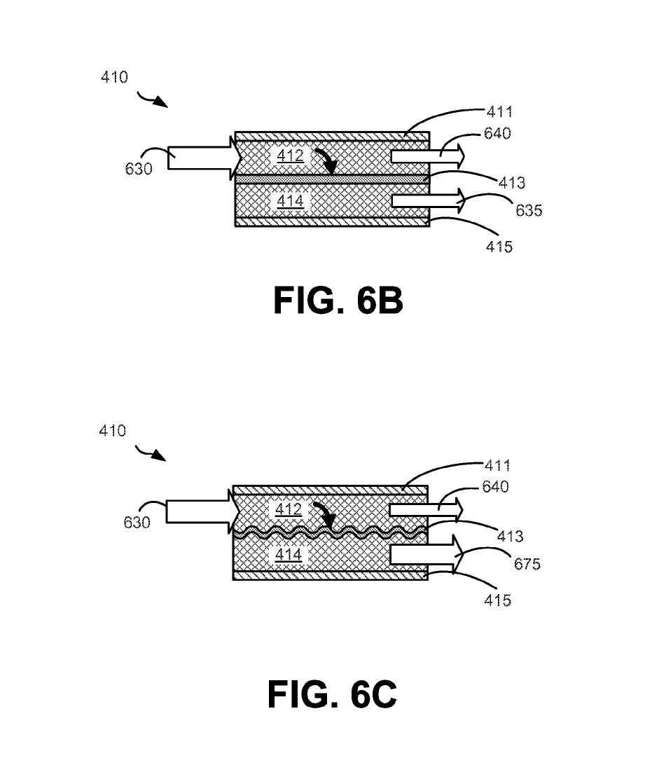

FIG. 6A depicts a flow chart illustrating an example method, in accordance with an embodiment.

FIG. 6B depicts a membrane assembly at a first point in time, according to the example method of FIG. 6A.

FIG. 6C depicts the membrane assembly of FIG. 6B at a second point in time, according to the example method of FIG. 6A.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that aspects of the present disclosure, as generally described herein, and illustrated in the figures, can be arranged, substituted, combined, separated, and/or designed in a wide variety of different configurations, all of which are explicitly contemplated herein.

### 1. Introduction

Described herein are aspects of apparatuses and methods to help reduce fouling and scaling of a membrane using ultrasonic vibrations in a variety of contexts, including, as one example, in reverse osmosis desalination. An embodiment of the present membrane assembly may be configured to direct ultrasonic waves at a membrane of the membrane assembly. The ultrasonic waves may be produced by a piezoelectric material. Further, in an embodiment, the ultrasonic waves may induce oscillations at the surface of the membrane and thereby prevent mineral particles and/or organic matters from settling on the membrane and/or cause at least some of any such settled particles to detach from the membrane. As a result, the membrane assembly described herein may be utilized to increase the efficacy and/or the longevity of the membrane, and thereby reduce the operating costs of treatment systems that utilize membranes.

As noted above, in one implementation, the disclosed membrane assembly may be employed in a reverse osmosis desalination system. Traditionally, in such a system, scaling, fouling, acid high velocity propulsion of solutions may decrease the lifetime and/or the efficacy of a membrane. Additional undesirable byproducts of such systems may also include harmful chemicals that are deposited in the environment. The membrane assembly described herein may help reduce fouling and scaling and may help reduce the necessary propulsion velocity of the solutions.

### 2. Example System

For purposes of context and explanation only, an example treatment system that incorporates the disclosed membrane assembly is discussed. However, it should be understood that aspects of the disclosed membrane assembly described herein may be utilized in other systems and/or contexts, including other treatment systems. Thus, the example treatment system discussed below should be understood to be but one example of a treatment system in which the disclosed membrane assembly may be utilized, and therefore should not be taken to be limiting.

a. Example Treatment System

FIG. 1 depicts a simplified block diagram of a treatment system 100 that includes an example membrane assembly 200, in accordance with an embodiment.

The treatment system 100 may be a water be a water treatment system (e.g., a desalination system or a water filtration system) or any other treatment system that may receive a solution containing a solute and a solvent and then output a solution containing the solvent and, at most, a portion of the solute.

The treatment system 100 may include a solution source 105 coupled to a pump 110, which, in turn, may be coupled to the membrane assembly 200. The membrane assembly 200 may be coupled to a waste reservoir 120 and an output reservoir 125. In example embodiments, the membrane assembly 200 may be communicatively coupled to a control device 130. In some embodiments, the control device 130 may also be communicatively coupled to the pump 110. Alternatively, a control device other than control device 130 may be communicatively coupled to the pump 110. Other components of the treatment system 100 may also be communicatively coupled to the control device 130 as well.

It should be understood that the various components of the treatment system 100 may each include one or more adapters, fittings, gaskets, valves or the like (hereinafter simply referred to as “adapters”) that may be configured to help direct the solution through treatment system 100. Accordingly, the, various components may be coupled to one another via any appropriate tubing, piping. Of other plumbing apparatus such that the solution may flow through the treatment system 100.

The solution source 105 may contain a solution. In one embodiment, the solution source 105 may be any apparatus configured or adapted to contain a solution. For example, the solution source 105 may be a vat, a tub, a tank, or any other suitable receptacle. In another embodiment, the solution source 105 may be any place that the solution exists in its natural environment. For example, the solution source 105 may be an ocean or a lake, among other examples.

The solution may be any liquid mixture that includes a solvent and a solute. In one example, the solvent may include water and the solute may include salt and/or other minerals. In another example, the solvent may include water and the solute may include waste matter (e.g., pathogens, organic particles, inorganic particles, toxins, etc.). Other examples are also possible, It should be understood that the term “solution” used herein may generally refer to a fluid that is to be filtered and that the term “solvent” used herein may refer to a fluid that has been filtered.

The solution source 105 may be configured to output the solution to the pump 110. The pump 110 may be configured to pressurize the solution to a predefined pressure. In one embodiment. the pump 100 may be configured to exert the predefined pressure upon the solution when the solution is passed through the membrane assembly 200. In another embodiment, the pump 110 may be configured to pressurize the solution and output the pressurized solution at a specified velocity at the membrane assembly 200. In one embodiment, the pump 110 may be configured to receive a signal from the control device 130 and pressurize the solution according to the received signal.

In one example, the predefined pressure may be a pressure up to 1300 pounds per square inch (psi). In another example, the predefined pressure may be a pressure from a range of pressures including 900 psi to 1100 psi. In other examples, the predefined pressure may be a pressure from about 250 psi to 1200 psi. Other pressures are also possible.

The waste reservoir 120 may be any suitable vat, tub, a tank, or any other suitable receptacle configured to contain solute. The waste reservoir 120 may be configured to receive waste material (e.g., the solute) directed from the membrane assembly 200. In one example, the waste reservoir 120 may be configured to receive and contain brine.

The output reservoir 125 may be any suitable vat, tub, a tank, or any other suitable receptacle configured to contain solvent. The output reservoir 125 may be configured to receive output solvent (e.g. water) from the membrane assembly 200. It should be understood that the output solvent may include some solute from the input solution. For example, the output solvent may include about 1% to 10% of the solute from the input solution. However, the output solvent may include more or less of the solute from the input solution.

The control device 130 may include at least one processor and memory. The processor may be configured to execute program instructions stored on the memory. The control device 130 may be configured to control certain operations of the treatment system 100. For example, the control device 130 may be configured to cause the pump 110 to pressurize the solution and/or the control device 130 may be configured to cause a piezoelectric material of the membrane assembly 200 to produce ultrasonic waves. In other examples, the control device 130 may be configured to cause the solution to be directed throughout the treatment system 100. For example, the control device 130 may be configured to cause an actuator to open or close one or more valves. In one embodiment, the control device 130 may be configured to cause a valve of the solution source 105 to open and allow the solution to enter the membrane assembly 200. In other embodiments, the control. device 130 may be configured to control a subsystem of the membrane assembly 200.

It should be understood that the treatment system 100 may include one or more other components not pictured, and/or the treatment system 100 may include more than one of the depicted components, without departing from the present invention. It should further be understood that the treatment system 100 is depicted to give an example context for the membrane assembly 200 and that the membrane assembly 200 may be utilized in other systems. For example, the membrane assembly 200 may be utilized in a forward osmosis water treatment system, a wastewater treatment system, a filtration system, or any other system that utilizes a membrane.

b. Example Membrane Assembly

FIG. 2 is a simplified block diagram of an embodiment 200 of a disclosed membrane assembly, which may be implemented as part of a treatment system (e.g., treatment system 100 of FIG. 1). The membrane assembly 200 may be implemented in other systems as well.

The membrane assembly 200 may include a piezoelectric material 220 physically coupled to a membrane 210. It should be understood that the piezoelectric material 220 may be physically coupled to the membrane 210 in a number of ways. Generally, the piezoelectric material 220 may be physically coupled to the membrane 210 in any manner in which ultrasonic waves produced by the piezoelectric material 220 may interact with the membrane 210. In one embodiment, the membrane 210 and the piezoelectric material 220 may be directly contacting each other. In other embodiments, there may be at least one intervening layer between the membrane 210 and the piezoelectric material 220.

In general, the membrane 210 may be a semipermeable membrane that includes pores that selectively allow certain molecules or ions to pass through while preventing others from passing through. That is, the membrane 210 may be configured to allow a solvent 235 of a solution 230 to pass through the membrane 210 and prevent at least some of a solute 240 of the solution 230 from passing through the membrane 210. In one embodiment, the membrane 210 may be configured such that the membrane blocks about 90% to 99% of solute of an input solution. The membrane 210 may be any suitable membrane depending on the particular treatment system that the membrane assembly 200 is implemented in.

In one embodiment, the membrane 210 may be a nano-filtration membrane. As such, the membrane 210 may be configured to have pore sizes in the range of 1-10 Angstroms. In one example membrane 210 may be configured to have a molecular weight cut-off (“MWCO”) of 3000 Daltons. In other embodiments, the membrane 210 may be configured to have a MWCO between about 1000 to 5000 Daltons. In other embodiments, the membrane 210 may be a sub-micro-filtration membrane, a micro-filtration membrane, or an ultra-filtration membrane.

The membrane 210 may be made out of any suitable material. In sonic embodiments, the membrane 210 may be a thin-film composite membrane. In particular, the membrane 210 may consist of at least polyamide or polyethylene sulfone, among other examples.

The piezoelectric material 220 may be configured to produce ultrasonic waves directed at the membrane 210 and thereby induce oscillations in at least a portion of the membrane 210. The piezoelectric material 220 may be configured or otherwise arranged to direct the ultrasonic waves at a direction perpendicular or oblique to the membrane 210. Consequently, the resulting oscillations may be normal or oblique to the surface of the membrane 210. In some embodiments, the oscillations induced in the membrane 210 may include a frequency and/or an amplitude that is the same as or similar to the ultrasonic waves directed at the membrane 210.

In some embodiments, the piezoelectric material 220 may be further configured to cause the ultrasonic waves to penetrate into the solution, the solute, and/or the solvent. Thus, the piezoelectric material 220 may be configured to produce ultrasonic waves that may add momentum to the solution and/or the membrane 210 such that impurities that impede the flow of solvent may be disrupted off of a boundary layer of the membrane 210.

The piezoelectric material 220 may be any material that is configured to exhibit the inverse piezoelectric effect. For example, in one embodiment. the piezoelectric material 220 may be a piezoelectric crystal, a piezoelectric ceramic (e.g., lead zirconate titanate), or a piezoelectric polymer (e.g., polyvinylidene difluoride (“PVDF”)), among other example piezoelectric materials.

In other embodiments, the piezoelectric material 220 ma y>be further configured to be permeable or impermeable. in some embodiments, the piezoelectric material 220 may be further configured such that the piezoelectric material 220 is flexible. As such, the piezoelectric material 220 may be arranged into the same shape as the membrane 210. For example, the piezoelectric material 220 may shaped into a spiral. In other embodiments, the piezoelectric material 220 may be further configured to be rigid.

In certain embodiments, the piezoelectric material 220 may be configured in any suitable geometric shape. For example, the piezoelectric material 220 may be shaped as a disk, a square, a rectangle, or a angle, among other shapes, In some embodiments, the shape and/or the size of the piezoelectric material 220 may depend on the size and/or the geometry of the treatment system that the membrane assembly 200 is implemented in.

In some embodiments, the piezoelectric material 220 may be configured as a supporting structure for the membrane 210. As such, the piezoelectric material 402 may be arranged in various manners. For example, referring to FIG. 3, which depicts a top-down view of an example membrane assembly 300, the piezoelectric material 220 may be arranged around the outer perimeter of the membrane 210 and physically coupled to the surface of the membrane 210. In such an example, the piezoelectric material 220 may be made of an impermeable material. In other embodiments, the piezoelectric material 220 may be configured to have the same geometry and/or size as the membrane 210 (as shown in FIG. 2). As such, the piezoelectric material 220 may be wholly or partially made of a permeable material. In one example, the piezoelectric material 22.0 may be made out of both permeable and impermeable materials. Other examples are also possible.

Referring back to FIG. 2, in certain embodiments, the membrane assembly 200 may optionally include a piezoelectric control device 225. The piezoelectric control device 225 may be configured to send signals to the piezoelectric material 220 to cause the piezoelectric material 220 to produce the ultrasonic waves. The piezoelectric control device 225 may include a signal generator that may be configured to produce the signals and a signal amplifier that may be configured to amplify the signals before the signals are sent to the piezoelectric material 220. The signal generator may be configured to output a signal with specified amplitude and a specified frequency. For example, the signal generator may be configured to output a signal with amplitude from about 100 mVpp to 900 mVpp and a frequency from about 20 kHz to 300 MHz. The signal amplifier may be a power amplifier, a power-per-demand, or any other amplifier type.

The piezoelectric control device 225 may further include at least one processor and memory, among other components. The processor may be configured to execute program instructions. In some embodiments, the piezoelectric control device 250 may be the control device 130, in other embodiments, the piezoelectric control device 225 may be a subsystem/device of the control device 130.

In some embodiments, the membrane assembly 200 may also optionally include a cooling system. The cooling system may be configured to vary the temperature of the solution 230 and/or the operating temperature of the piezoelectric material 220. For example, the cooling system may be configured to decrease the temperature of the solution 230. In such an example, the solution 230 may be cooled prior to entering the membrane assembly 200 or once in the membrane assembly 200. In another example, the cooling system may be configured to circulate a coolant around at least a portion of the piezoelectric material 220.

c. Example Membrane Assemblies

FIG. 2 depicts one example membrane assembly that may be implemented in a treatment system. Other membrane assemblies are also contemplated herein. Below various such example membrane assemblies and aspects thereof are discussed. However, it should be understood that this is for purposes for example and explanation only. Other examples may exist and the claims should not be limited to the particular examples or aspects thereof described herein.

FIGS. 4A-4F illustrate example membrane assemblies according to example embodiments. For clarity, the example membrane assemblies are shown without certain components (e.g., the piezoelectric control device 225). However, it should be understood that such components may be communicatively coupled to the membrane assemblies, unless context dictates otherwise.

Furthermore, the example membrane assemblies may be described below as including various combinations of membranes, piezoelectric materials, and/or spacers. It should be understood that, unless context dictates otherwise, a membrane may refer to any membrane described above (e.g., the membrane 210) and a piezoelectric material may refer to any piezoelectric material described above (e.g., the piezoelectric material 220).

With respect to the spacers as discussed herein, a spacer may be a material configured to support a membrane and facilitate the flow of fluid to the membrane, in some embodiments, the spacer may include a non-liquid material physically coupled to the membrane. In one embodiment, a spacer may be made out of a porous material. For example, a spacer may be made out of a porous plastic, among other materials. In other embodiments, a spacer may be configured to direct ultrasonic waves at a membrane. As such, the spacer may be made wholly or partially out of a permeable or impermeable piezoelectric material such as a piezoelectric polymer.

FIG. 4A shows a simplified side view of a membrane assembly 400. The membrane assembly 400 may include a membrane 401 physically coupled to a piezoelectric material 402. As shown, the membrane assembly 400 may be configured such that the solvent 235 may pass through the piezoelectric material 402 and then the membrane 401 at a direction perpendicular or oblique to the piezoelectric material 402 and the membrane 401 (as indicated by the black arrow). Additionally, the membrane assembly 400 may be configured to prevent the solute 240 from passing through the membrane 401. It should be understood that the membrane assembly 400 might be configured such that a pressure may be exerted on the solution 230 as it passes over the membrane assembly 400, which may cause the solution 230 to be directed towards the piezoelectric material 402 and the membrane 401.

FIG. 4B shows a simplified view of an example membrane assembly 410. The membrane assembly 410 may include a first piezoelectric material 411 physically coupled to a first spacer 412, which in turn may be physically coupled to a membrane 413. The membrane 413 may also be coupled to a second spacer 414, which in turn may be physically coupled to a second piezoelectric material 415, in this example, each of the piezoelectric materials 411 and 415 may be an impermeable piezoelectric material. As such, the piezoelectric materials may be further configured to help direct the solution 230 towards the membrane 413.

As shown, the membrane assembly 410 may be configured such that the solution 230 may be directed through the spacer 412 and parallel to the membrane 413. Furthermore, the membrane assembly 410 may be configured such that the solvent 235 may pass through the membrane 413 at a direction perpendicular or oblique to the membrane 413 (as indicated by the black arrow). Additionally, the membrane assembly 410 may be configured to prevent the solute 240 from passing through the membrane 413. It should be understood that the membrane assembly 410 might be configured such that a pressure may be exerted on the solution 230 as it passes through the membrane assembly 410, which may cause the solution 230 to be directed towards the membrane 413.

FIG. 4C shows a simplified view of an example membrane assembly 420. The membrane assembly 420 may include a first membrane 421 that may be physically coupled to a first spacer 422, which in turn may be physically coupled to a piezoelectric material 423. The piezoelectric material 423 may be physically coupled to a second spacer 424, which in turn may be physically coupled to a second membrane 425.

As shown, the membrane assembly 420 may be configured such that the solution 230 may be directed through the spacers 422 and 424 and parallel to the membranes 421 and 425. Furthermore, the membrane assembly 420 may be configured such that the solvent 235 may pass through the membranes 421 and 425 at a direction perpendicular or oblique to the membranes (as indicated by the black arrows), Additionally, the membrane assembly 420 may be configured to prevent the solute 240 from passing through the membranes 421 and 425. It should be understood that the membrane assembly 420 might be configured such that a pressure may be exerted on the solution 230 as it passes through the membrane assembly 420, which may cause the solution 230 to be directed towards the membranes 421 and 425.

FIG. 4D shows a simplified view of an example membrane assembly 430. The membrane assembly 430 may include a first piezoelectric material 431 that may be physically coupled to a first membrane 432, which in turn may be physically coupled to a spacer 433. The spacer 433 may be physically coupled to a second membrane 434, which in turn may be physically coupled to a second piezoelectric material 435.

As shown, the membrane assembly 430 may be configured such that the solution 230 may be directed through the spacer 433 and parallel to the membranes 432 and 434 and the piezoelectric materials 431 and 435. Furthermore, the membrane assembly 430 may be configured such that the solvent 235 may pass through the membranes and the piezoelectric materials at a direction perpendicular or oblique to them (as indicated by the black arrows). Additionally, the membrane assembly 430 may be configured to prevent the solute 240 from passing through the membranes 432 and 434. It should be understood that the membrane assembly 430 might be configured such that a pressure may be exerted on the solution 230 as it passes through the membrane assembly 430, which may cause the solution 230 to be directed towards the membranes 432 and 434.

In one alternative embodiment of the membrane assembly 430, the first piezoelectric, material 431 may be arranged below the first membrane 432. In another alternative embodiment of the membrane assembly 430, the second piezoelectric material 435 may be arranged above the second membrane 434.

FIG. 4E shows a simplified view of an example membrane assembly 440. The membrane assembly 440 may include a first membrane 441 that may be physically coupled to a first piezoelectric material 442, which in turn may be physically coupled to a spacer 443. The spacer 443 may be physically coupled to a second piezoelectric material 444, which in turn may be physically coupled to a second membrane m material 445,

As shown, the membrane assembly 440 may be configured such that the solution 230 may be directed parallel to the membranes 441 and 445. Additionally, the membrane assembly 440 may be configured such that the solvent 235 may pass through the membranes 441 and 445 and the piezoelectric materials 442 and 444 at a direction perpendicular or oblique to them (as indicated by the black arrows). Additionally, the membrane assembly 440 may be configured to prevent the solute 240 from passing through the membranes 441 and 445. It should be understood that the membrane assembly 440 might be configured such that a pressure may be exerted on the solution 230 as it passes over the membrane assembly 440, which may cause the solution 230 to be directed towards the membranes 441 and 445.

In one alternative embodiment of the membrane assembly 440, the first piezoelectric material 442 may be arranged above the first membrane 441. In another alternative embodiment of the membrane assembly 440, the second piezoelectric material 444 may be arranged below the second membrane 445.

FIG. 4F shows a simplified view of an example membrane assembly 450. The membrane assembly 450 may include a first spacer 451 that may be physically coupled to a first piezoelectric material 452, which in turn may be physically coupled to a membrane 453. The membrane 453 may be physically coupled to a second piezoelectric material 454, which in turn may be physically coupled to a second spacer 455. In this example, the piezoelectric materials may be made out of permeable materials. The piezoelectric materials 452 and 453 and/or the spacers 451 and 455 may be electrically coupled to a voltage source (e.g., the piezoelectric control device 225). Accordingly, piezoelectric materials 452 and 453 and/or the spacers 451 and 455 may be configured to carry an electrical potential such that when a voltage is applied across the piezoelectric materials or the spacers, they may mechanically strain the membrane 453 (e.g., by shearing or compressing the membrane 453). Such a mechanical strain may disrupt a boundary layer of the membrane 453, which may enhance the flow rate of solvent passing through the membrane 453.

As shown, the membrane assembly 450 may be configured such that the solution 230 may be directed through the first spacer 451 and parallel to the membrane 453. The membrane assembly 450 may also be configured such that the solvent 235 may pass through the membrane 453 and the two piezoelectric materials at a direction perpendicular or oblique to them (as indicated by the black arrow). Further, the membrane assembly 450 may be configured to prevent the solute 240 from passing through the membrane 453. It should be understood that the membrane assembly 450 might be configured such that a pressure may be exerted on the solution 230 as it passes through the membrane assembly 450, which may cause the solution 230 to be directed towards the e first piezoelectric material 452. and the membrane 453.

d. Example Application

FIG. 5A depicts an example application of a membrane assembly described herein. FIG. 5 illustrates a membrane housing 500 that utilizes at least one membrane assembly. Below an example membrane housing and aspects thereof are discussed. However, it should be understood that this is for purposes for example and explanation only. Other example applications may exist and the claims should not be limited to the particular examples or aspects thereof described herein. Those skilled in the art will appreciate that FIG. 5 depicts a membrane housing similar, in some respects, to a spiral bound reverse osmosis membrane housing.

As shown in FIG. 5, the membrane housing 500 may include an outer wrap 505, a collection tube 510, one or more membrane assemblies 515, and at least two support devices 525 (only one is shown) located on both ends of the membrane housing 500. Each support device 525 may include at least one piezoelectric material 550. Accordingly, the membrane housing 500 may include a piezoelectric control device 555 that is communicatively coupled to the piezoelectric material 550. The piezoelectric control device 555 may be the same as or similar to the piezoelectric control device 225. In some embodiments, at least one piezoelectric material may be coupled to the outer wrap 505. In any event, the piezoelectric material 550 may be configured and/or arranged to direct ultrasonic waves at the membrane assemblies 515.

The membrane housing 500 may be configured to have a solution 230 directed through the membrane housing 500. Further, each membrane assembly 515 may be configured to allow a solvent 235 of the solution 230 to pass through the membrane assembly 515 and collect in the collection tube 510. Accordingly, the collection tube 510 may be configured to collect the solvent 235 and direct the solvent 235 out of the membrane housing 500. in one instance, the collection tube 510 may be perforated. The membrane assembly 515 may be further configured to prevent a solute 240 of the solution 230 from passing through the membrane assemblies 515 into the collection tube 510.

The membrane housing 500 may include adapters (not shown) that are configured to couple the membrane housing 500 to the other components of a treatment system, e.g., the treatment system 100. For example, the membrane housing 500 may include an adapter configured to couple the collection tube 510 to the output reservoir 125.

Each support device 525 configured to couple the various elements and membrane assemblies 515 of the membrane housing 500 together. In one embodiment, the support device 525 may be anti-telescoping device configured to prevent the membrane assemblies 515 and/or the outer wrap 505 from unraveling and/or overextending. The support device 525 may be configured to be placed over the outer wrap 505 and receive the collection tube 510 inserted into the support device 525.

FIG. 5B depicts the membrane assembly 515 of FIG. 5A according to an embodiment. Each membrane assembly 515 may include a membrane 516, a spacer 517, at least one piezoelectric material 518, and an additional layer 519. The membrane 516 may be any membrane described herein. The spacer 517 may be the any spacer described above, may be configured to direct the solution 230 over the surface of the membrane 516. The piezoelectric material 518 may be any piezoelectric material described herein, It should be understood that the piezoelectric material 518 may be same as, similar to, or different than the piezoelectric material 550. For example, in one embodiment, the piezoelectric material 515 may be made of a permeable material, and the piezoelectric material 550 may be made of an impermeable material. Other examples are also possible. In sonic embodiments, the additional layer 519 may be configured to collect the solvent 235 and direct the solvent 235 to the collection tube 510. Other example additional layers are also possible.

As shown, the piezoelectric material 518 may be coupled to or part of the spacer 517. In another embodiment, piezoelectric material may be coupled to or part of the membrane and/or the collection layer. In any regard, the piezoelectric material 518 may be configured to induce oscillations in the membrane 516.

The membrane assembly 515 may be configured or otherwise arranged in the same or similar manner as the above described membrane assemblies (e.g., membrane assemblies 200, 400, 410, 420, 430, 440, and 450). The membrane assembly 515 may be wound info a spiral as indicated by the black arrows. As such, the piezoelectric material 518 may be shaped in a spiral and/or made out of a flexible material.

It should be understood that the membrane assembly 500 is depicted in a context similar to a spiral bound reverse osmosis membrane housing for purposes of example and explanation only and should not be taken as limiting. Other example membrane housings are also possible, For example, a membrane housing similar to the membrane assembly 500 may be employed in the context of a hollow fiber membrane. In particular, the described piezoelectric material may be arranged on an inner wall of a hallow fiber membrane and/or on an outer shell that contains the hallow fiber membrane. Other applications are also possible.

### 3. Example Method

FIG. 6A is a flow chart illustrating a method 600, according to an example embodiment. In general, any of the membrane assemblies described herein may carry out the method 600 as described below. in certain embodiment, method 600 may be carried out entirely, or in part, by a control device (e.g., the control device 130) in communication with the membrane assembly or some other computing system communicatively coupled with the membrane assembly. For purposes of example and explanation only, the method 600 will be illustrated below with reference to membrane assembly 410, but it should be understood that any of the described membrane assemblies might be used to perform the method 600.

As shown in FIG. 6A, method 600 begins at block 602 with directing a solution to a membrane of a membrane assembly, where the membrane passes a solvent of the solution through the membrane at a first rate, and where the membrane prevents at least some of a solute of the solution from passing through the membrane. At block 604, the method 600 involves causing a piezoelectric material that is physically coupled to the membrane to produce ultrasonic waves directed at the membrane, where the ultrasonic waves induce oscillations in at least a portion of the membrane and thereby the solvent of the solution passes through the membrane at a second rate that is greater than the first rate. Each of the blocks shown with respect to FIG. 6A is discussed further below.

a. Direst Solution to Membrane

The method 600 begins at block 602 with directing a solution to a membrane of a membrane assembly, where the membrane passes a solvent of the solution through the membrane at a first rate, and where the membrane prevents at least sonic of a solute of the solution from passing through the membrane.

The solution may be the same as or similar to the solution discussed above with reference to FIG. 1. In some embodiments, the membrane assembly may direct the solution to the membrane. In other embodiments, one or more external components (e.g. the control device 130) may direct the solution or cause another component to direct the solution to the membrane. For example, the solution source 105 and/or the pump 110 may direct or may aid in directing the solution to the membrane. In one embodiment, directing the solution to the membrane may involve the control device 130 opening a valve to allow the solution to contact the membrane. Other examples are also possible.

With reference to FIG. 6B, which depicts the membrane assembly 410 at a first point in time according to the method 600, the membrane assembly 410 may direct a solution 630 to the membrane 413 (as indicated by the black arrow). The membrane 413 may pass a solvent of the solution through the membrane 413 at a first rate 635, and the membrane 413 may prevent at least some of a solute 640 of the solution from passing through the membrane 413. The first rate 635 at which the solvent passes through lire membrane 413 may be affected by solute deposits that accumulate on a boundary of the membrane 413. The deposits may include organic and/or inorganic materials from the solute, among other materials, that clog or otherwise impede the amount of solvent that may pass through the pores of the membrane 413.

b. Cause Piezoelectric Material to Produce Ultrasonic Waves

As shown by block 604, the method 600 involves causing a piezoelectric material that is physically coupled to the membrane to produce ultrasonic waves directed at the membrane, where the ultrasonic waves induce oscillations in at least a portion of the membrane and thereby the solvent of the solution passes through the membrane at a second rate that is greater than the first rate.

In some embodiments, causing the piezoelectric material to produce ultrasonic waves directed at the membrane may involve the piezoelectric material receiving signals from the piezoelectric control device 225. The signals Wray be the e same as or similar to the signals as discussed above with reference to FIG. 2. For example, the signals may be ultrasonic signals received from the piezoelectric control device 225.

In one embodiment, the signals may be continuous or intermittent. For example, causing the piezoelectric material to produce ultrasonic waves may comprise the piezoelectric material receiving intermittent signals from the piezoelectric control device and in response, the piezoelectric material outputting intermittent pulses of ultrasonic waves. In one example, the piezoelectric material may receive a signal from the piezoelectric control device once per six horns, once per two hours, once per horn, once per minute, once per 30 seconds, or once per 10 seconds. Other intermittent signal intervals are also possible. Further, in certain embodiments, the piezoelectric material may receive the intermittent signals for a predefined time duration, e.g., 10 hours, 6 hours, 2 hours, 1 hour, 1 minute, 30 seconds, etc.

With reference to FIG. 6C, which depicts the membrane assembly 410 at a second point in time according to the method 600, the piezoelectric material 411 and/or 415 may be caused to produce ultrasonic waves directed at the membrane 413. The ultrasonic waves may induce oscillations in at least a portion of the membrane 413 and thereby the solvent of the solution may pass through the membrane 413 at a second rate 675 that is greater than the first rate 635 (as indicated by the relative widths of the arrows 635 and 675). Such oscillations may be normal to the surface of the membrane (as shown in FIG. 6C). The oscillations may have a frequency and/or an amplitude that correspond to the parameters of the signals received by the piezoelectric materials 411 and/or 415. For example, the oscillations in at least a portion of the membrane 413 may include an amplitude from about 100 mVpp to 900 mVpp and/or a frequency from about 20 kHz to 300 MHz. Other examples are also possible.

The increased second rate 675 at which the solvent passes through the membrane 413 may be a result of the induced oscillations removing impediments from the pores of the membrane 413. That is, the induced oscillations in the membrane 413 may cause one or more deposits to detach from the membrane 413 and thereby allow an increased amount of solvent to pass through.

In sonic embodiments, the method 600 may optionally involve pressurizing the solution to a predefined pressure as the solution is directed over the membrane. The pump 110 may be used to pressurize the solution. In some instances, the predefined pressure may be a pressure from about 900 psi to 1100 psi. Other example pressure ranges are also possible, for example, as discussed above with reference to FIG. 1.

In other embodiments, the method 600 may optionally involve distributing a coolant around at least a portion of the piezoelectric material. A cooling system may be used to distribute the coolant around at least a portion of the piezoelectric material. In some instances, the coolant may be the solution chilled by the cooling system. Other examples are also possible.

### 4. Conclusion

While various aspects and embodiments have been disclosed herein, other aspects and embodiments will be apparent to those skilled in the art. For example, with respect to the flow charts depicted in the figures and discussed herein, functions described as blocks may be executed out of order front that shown or discussed, including substantially concurrent or in reverse order, depending on the functionality involved. Further, more or fewer blocks and/or functions may be used and/or flow charts may be combined with one another, in part or in whole.

A block that represents a processing of information may correspond to circuitry that can be configured to perform the specific logical functions of a herein-described method or technique. Alternatively or additionally, a block that represents a processing of information Wray correspond to a module, a segment, or a portion of program code (including related data). The program code may include one or more instructions executable by a processor for implementing specific logical functions or actions in the method or technique.

The various aspects and embodiments disclosed herein are for purposes of illustration and are not intended to be limiting, with the true scope and spirit being indicated by the following claims, Other embodiments can be utilized, and other changes can be made, without departing from the spirit or scope of the subject matter presented herein.

We claim:

1. A membrane assembly comprising:
a membrane, wherein the membrane is configured to allow a solvent of a solution to pass through the membrane, and wherein the membrane is configured to prevent at least some of a solute of the solution from passing through the membrane; and
a piezoelectric material physically coupled to the membrane, wherein the piezoelectric material is configured to produce ultrasonic waves directed at the membrane and thereby induce oscillations in at least a portion of the membrane.

2. The membrane assembly of claim 1, wherein the solvent comprises water, and wherein the solute comprises at least one of salt and waste matter.

3. The membrane assembly of claim 1, wherein the membrane comprises one of a polyamide membrane and a polyethylene sulfone membrane.

4. The membrane assembly of claim 1, wherein the piezoelectric material comprises a piezoelectric ceramic.

5. The membrane assembly of claim 1, wherein the piezoelectric material comprises a polyvinylidene difluoride material.

6. The membrane assembly of claim 1, further comprising a piezoelectric control device that is communicatively coupled to the piezoelectric material.

7. The membrane assembly of claim 6, wherein the piezoelectric control device is configured to output to the piezoelectric material a signal comprising an amplitude from the range of about 100 mVpp to 900 mVpp.

8. The membrane assembly of claim 6, wherein the piezoelectric control device is configured to output to the piezoelectric material a signal comprising a frequency from the range of about 20 kHz to 300 MHz.

9. A method comprising:
directing a solution to a membrane of a membrane assembly, wherein the membrane passes a solvent of the solution through the membrane at a first rate, and wherein the membrane prevents at least some of a solute of the solution from passing through the membrane; and
causing a piezoelectric material that is physically coupled to the membrane to produce ultrasonic waves directed at the membrane, wherein the ultrasonic waves induce oscillations in at least a portion of the membrane and thereby the solvent of the solution passes through the membrane at a second rate that is greater than the first rate.

10. The method of claim 9, wherein the solvent comprises water, and wherein the solute comprises at least one of salt and waste matter.

11. The method of claim 9, wherein the membrane comprises one of a polyamide membrane and a polyethylene sulfone membrane.

12. The method of claim 8, wherein the piezoelectric material comprises a piezoelectric ceramic.

13. The membrane assembly of claim 1, wherein the piezoelectric material comprises a polyvinylidene difluoride material.

14. The method of claim 8, wherein causing the piezoelectric; material to produce ultrasonic waves comprises causing the piezoelectric material to produce intermittent ultrasonic waves.

15. The method of claim 8, wherein the induced oscillations in the membrane cause one or more deposits to detach from the membrane, wherein the one or more deposits comprise at least some of the solute of the solution.

16. The method of claim 8, wherein the at least a portion of the membrane oscillates with an amplitude from the range of about 100 mVpp to 900 mVpp.

17. The membrane assembly of claim 8, wherein the at least a portion of the membrane oscillates with a frequency from the range of about 20 kHz to 300 MHz.

18. A membrane assembly comprising:
a membrane, wherein the membrane is configured to allow a solvent of a solution to pass through the membrane, and wherein the membrane is configured to prevent at least some of a solute of the solution from passing through the membrane; a spacer physically coupled to the membrane, wherein the spacer is configured to
direct the solution through the membrane assembly; and
a piezoelectric material physically coupled to the spacer, wherein the piezoelectric material is configured to produce ultrasonic waves directed at the membrane and thereby induce oscillations in at least a portion of the membrane.

19. The membrane assembly of claim 18, wherein the piezoelectric material comprises an impermeable piezoelectric material.

20. The membrane assembly of claim 18, wherein the induced oscillations in the at least portion of the membrane comprises at least one of an amplitude of about 100 mVpp to 900 mVpp and a frequency of about 20 kHz to 300 MHz.
